(19) United States
(12) Patent Application Publication
(10) Pub. No.: US 2025/0322035 A1
(43) Pub. Date: Oct. 16, 2025

(54) SPARSE STOCHASTIC LIBRARIES WITH SPATIAL CORRELATION

(71) Applicant: ANALYCORP, INC., PALO ALTO, CA (US)

(72) Inventor: Sam L. Savage, Palo Alto, CA (US)

(21) Appl. No.: 19/053,137

(22) Filed: Feb. 13, 2025

Related U.S. Application Data
(63) Continuation-in-part of application No. 18/450,540, filed on Aug. 16, 2023.
Application No. 18/450,540 is a continuation of application No. 16/447,742, filed on Jun. 20, 2019, now Pat. No. 11,775,609.
(63) Continuation-in-part of application No. 18/412,313, filed on Jan. 12, 2024.
Application No. 18/412,313 is a continuation of application No. 17/727,629, filed on Apr. 22, 2022, now abandoned.
Application No. 17/727,629 is a continuation of application No. 15/494,431, filed on Apr. 21, 2017, now abandoned.
(63) Continuation-in-part of application No. 18/990,479, filed on Dec. 20, 2024.
(60) Provisional application No. 62/325,931, filed on Apr. 21, 2016.
(60) Provisional application No. 62/687,690, filed on Jun. 20, 2018.
(60) Provisional application No. 62/831,105, filed on Apr. 8, 2019.
(60) Provisional application No. 63/612,742, filed on Dec. 20, 2023.
(60) Provisional application No. 63/554,075, filed on Feb. 15, 2024.

(51) Int. Cl. G06F 17/18

(52) U.S. Cl. CPC G06F 17/18

(57) ABSTRACT

A method according to an embodiment conveys the full distribution of hazard intensity while preserving spatial correlations, including the chances of simultaneous risk events. Sparse Monte Carlo and event Polygons reduce storage requirements by orders of magnitude compared to Pixel based approaches.

### PRIORITY CLAIM

This application claims priority to U.S. Provisional Application No. 63/554,075, filed Feb. 15, 2024; the contents of which are hereby incorporated by reference in their entirety as if fully set forth herein. This application is a continuation-in-part of U.S. Non-Provisional application Ser. No. 18/990,479, filed Dec. 20, 2024, which claims priority to U.S. Provisional Application No. 63/612,742, filed Dec. 20, 2023; This application is a continuation-in-part of U.S. Non-Provisional application Ser. No. 18/450,540, filed Aug. 16, 2023; U.S. Non-Provisional application Ser. No. 16/447,742, filed Jun. 20, 2019, which claims priority to U.S. Provisional Application No. 62/687,690, filed Jun. 20, 2018 and U.S. Provisional Application No. 62/831,105, filed Apr. 8, 2019. This application is a continuation-in-part of U.S. Non-Provisional application Ser. No. 18/412,313, filed Jan. 12, 2024, U.S. Non-Provisional application Ser. No. 17/727,629, filed Apr. 22, 2022, U.S. Non-Provisional application Ser. No. 15/494,431, filed Apr. 21, 2017, which claims priority to Provisional Application No. 62/325,931, filed Apr. 21, 2016. All of the aforementioned applications are hereby incorporated by reference as if fully set forth herein.

### COPYRIGHT NOTICE

This disclosure is protected under United States and/or International Copyright Laws. © 2025 AnalyCorp. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BRIEF DESCRIPTION OF THE DRAWING FIGURES

FIGS. 1-25 illustrate features of one or more embodiments of the invention.

### DETAILED DESCRIPTION

An embodiment includes developing a practical approach for extracting data from large hazard simulations to aid non-technical managers at all levels in making chance-informed decisions. The customary approach of tracking average hazard intensity over a region results in the Flaw of Averages, a family of systematic errors. In contrast, an approach according to an embodiment conveys the full distribution of hazard intensity while preserving spatial correlations, including the chances of simultaneous risk events. Sparse Monte Carlo and event Polygons reduce storage requirements by orders of magnitude compared to Pixel based approaches.

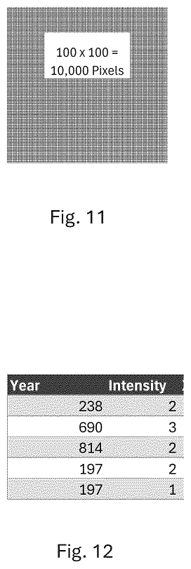

Referring to FIG. 11, the demo models discussed here address a hypothetical wildfire hazard over a 10-mile square region broken up into a 1/10^{th} mile square grid, for a total of 100²=10,000 pixels. It is based on 1,000 simulated trials of fire intensity for each pixel for a total of 10 million numbers. The use of Sparse Monte Carlo Polygons, discussed below, reduces the storage of simulation results to 2,000 numbers, 0.02% of the original, making this practical even for much larger problems.

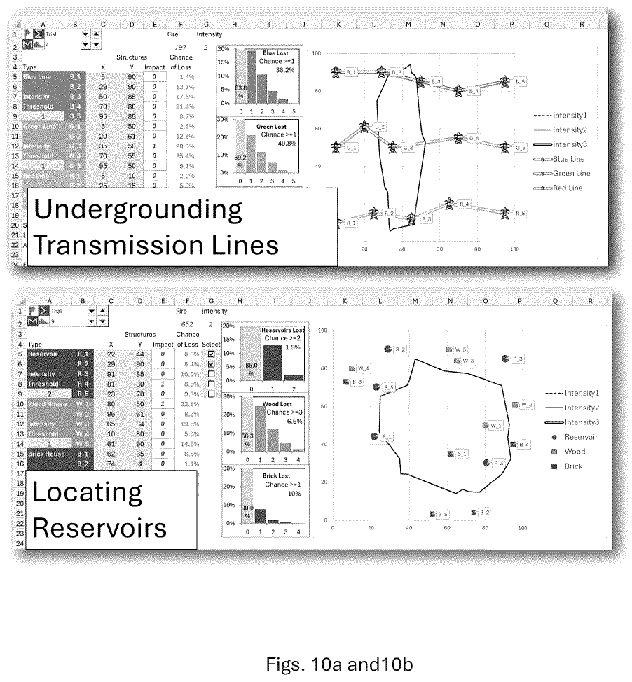

Referring to FIGS. 10a-10b, one can demonstrate two areas of application in which the use of average hazard gives erroneous results, while the full Pixel approach would be impractical due to storage requirements.

### Undergrounding Transmission Lines

California Senate Bill 884 requires the (California Public Utilities) “Commission (CPUC) to establish a program for expediting the undergrounding of a utility's electric distribution infrastructure.” Our demo model shows that averages or even distributions of hazard without spatial correlation cannot adequately convey the risk reduction of undergrounding the lines, as required by SB 884.

### Location of Water Reservoirs

A serious risk from wildfire is ash contamination to municipal reservoirs. Given the likelihood of fire at each reservoir, the obvious thing to do is estimate total risk by adding the expected (average) risk at each reservoir. But the obvious approach is wrong on two counts. First, averages do not indicate the range of possible outcomes. Second, they ignore spatial correlations between reservoirs, which impacts the chances of losing multiple reservoirs at once, placing the entire region's drinking water at risk.

Referring to FIG. 12, the data format in these models is posed as a rough draft of the ultimate version to be developed by the CHANCES Consortium. It has two fields and 1,000 records, one for each fire event.

Year of fire event. The expected number of fires is one per year, with some years having none and some more than one.

Intensity of Fire. Modelled as level 1 through 3. This could be expanded to any number, or a continuous variable, which would map into flame lengths, with fragility curves for the structures impacted.

Polygons. A Polygon of burn area is associated with each row of data (fire event) but is not used in the simulation itself. Instead, before the simulation is run, for each asset a list of polygons that contain the asset is generated and identified by row number.

### Undergrounding Electric Transmission Lines

As above alluded to, California Senate Bill 884 requires the (California Public Utilities) “Commission (CPUC) to establish a program for expediting the undergrounding of a utility's electric distribution infrastructure.”

The goals of undergrounding are to both reduce the need for Public Safety Power Shutoff events during high wildfire danger and to reduce the risks of wildfires in the first place. The large Independently Owned Utilities (IOUs) in California base their undergrounding decisions on the results of massive, sophisticated simulations of fire ignition and spread. They take numerous factors into account, such as weather, terrain, fuel load, etc. It is the role of the CPUC to assess and approve the cost efficiency of these risk reduction measures, but without technical training the hazard simulations are difficult to interpret. Often the only data used from these simulations are averages or probabilities of fire by location, which does not preserve spatial correlation.

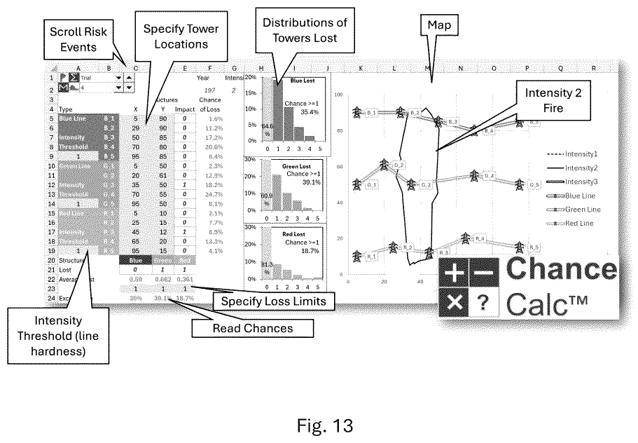

Referring to FIG. 13, The CHANCES Undergrounding proof-of-concept dashboards use data similar to that which could easily be extracted from the IOU's simulations. It demonstrates that such data may be used in an Excel model, without macros or add-ins, or any other software environment to create interactive simulations. This can foster a chance-informed conversation between the IOU's, CPUC, and other non-technically trained stakeholders, including financial managers in local government.

Model created with ChanceCalc from nonprofit ProbabilityManagement.org.

Performs 1,000 simulation trials in native Excel without macros or add-ins.

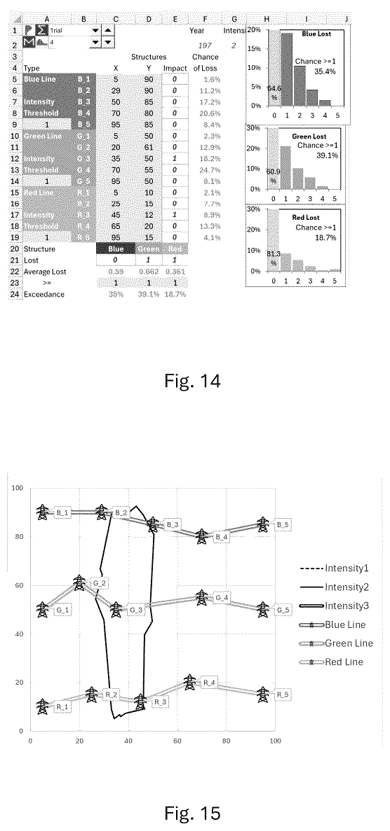

FIG. 14: The Undergrounding Dashboard-CHANCES Undergrounding Demo.xlsx

### Transmission Lines

There are three transmission lines in the model: Blue, Green and Red.

### Intensity Threshold

This threshold specifies the lowest fire intensity at which the towers making up the line are lost. Increasing this number essentially hardens the line to fire hazard.

### Structures

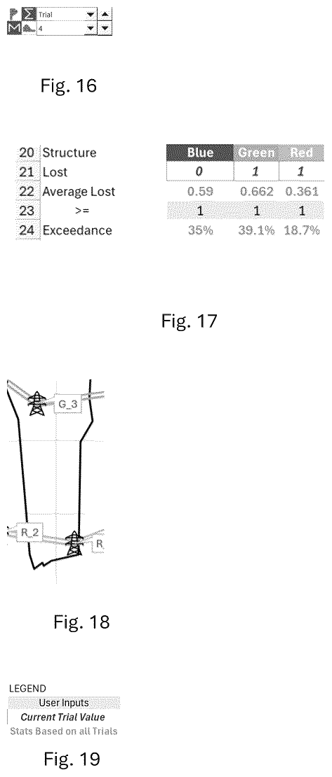

The structures in this model are transmission towers, and each has an X, Y coordinate on the map. These may be edited to observe how the risks would change with the location of the towers. The impact column indicates whether a structure is lost or not (designated by 1 or 0) on a single observed simulation trial. Trial 4 is shown, as indicated by the trial control at the top of the screen (FIG. 16). The Chance of Loss column is based on all 1,000 trials within the simulation.

### Statistics and Histograms

Average towers lost by line are shown in row 22, with loss limits and exceedance chances shown in rows 23 and 24. The histograms on the right display the chances of losing various numbers of towers within a given line. The first bar (zero lost towers) is grey, because it is not drawn to scale with the other loss numbers.

### Map

Referring to FIG. 15, the map displays the locations of all towers and the fire polygon for the current trial, in this case 4. It displays a fire of intensity 2, which has destroyed the third tower in both the green and red line and extends to the blue line where no towers were impacted.

### Exploring the Model

Referring to FIG. 16, start by scrolling through a few trials with the Trials Control in the upper left of the dashboard. You will see a different polygonal fire on each trial, along with its intensity and the simulated year in which it took place. Note that there can be more than one fire per year, and some years may not have a fire. All statistics are based on annual loss over 1,000 simulated years of fire activity with an average of one fire per year.

### Which Line Should We Underground?

Referring to FIGS. 17-18, suppose that under SB 884 your utility was planning to underground one of these lines. It would make sense to underground the one at the greatest risk. Observing the statistics in the lower left of the dashboard we see that the annual average number of structures lost is the highest for the Green Line at 0.662 per year and lowest for the Red Line at 0.361 per year. We also see that the chance of losing at least one structure is again the greatest for Green at 39.1% and the least for Red at 18.7. Line 21 contains the structures lost on each trial. For trial 4 displayed here, we see that the Green and Red Line have both lost one structure as shown in the map.

### The Interactivity of ChanceCalc Models

Referring to FIG. 19, the ChanceCalc add-in from nonprofit ProbabilityManagement.org creates interactive simulations in native Excel through the use of the Data Table function. As a result, models such as the two described in this document, run in native Excel without the use of the add-in itself. Beyond the normal cells there are two more categories one should be aware of: Those that show values associated with the current trials, and those that show statistics based on all trials, 1,000 in this case. These categories are displayed in the legend shown here.

With Trials still set to 4, move Tower R3 to the East by changing its X coordinate, cell C17 from 45 to 50. This moves it out of the fire region for this trial and E17 will turn from 1 to 0. Be sure to return C17 to 45 before proceeding, to get correct results in the remaining discussion.

### The Impact of Spatial Correlation

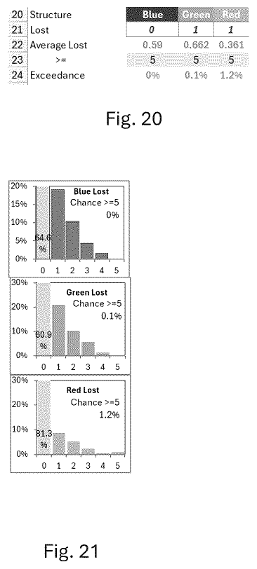

Referring to FIGS. 20-21, so far, it appears that the Red Line is the least likely candidate for undergrounding as it has the lowest average risk and lowest risk of losing a single structure. But focusing on the catastrophic risk of losing all five towers tells a different story. Raise the structures lost to 5, in cells C23:E23, and the Red Line has the highest chance of exceedance at 1.2%, over ten times that of the Green Line. This may be viewed either in the Histograms or in row 24. NOTE: Row 21 values are from the current trial, rows 22 and 24 are statistics based on all trials, and row 23 are user inputs. This tail risk of the Red Line is due to the fact that the spatial correlation causes there to be a significant number of trials in which the entire Red Line is within the burn region. Typically, a rational risk attitude would rate losing all five towers as more than 5 times as bad as losing a single tower, in which case the Red Line is the most important one to be undergrounded. None of this would be apparent with the Averages in row 22 alone.

You may continue exploring the model by changing any blue cell. These include the locations of each tower, and the thresholds of the lines, which impact their hardness.

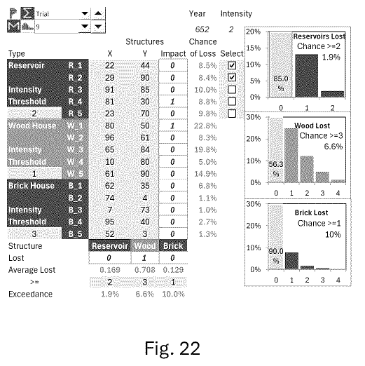

FIG. 22: The Reservoir Dashboard

### CHANCES Reservoir Demo

### Structures

Each structure type has a specified intensity threshold for fire impact.

### Reservoirs

There are five reservoirs of which you must choose two. The goal is to minimize the chance of losing both to the same fire.

### Houses

Five each, wooden and brick houses.

### Impact

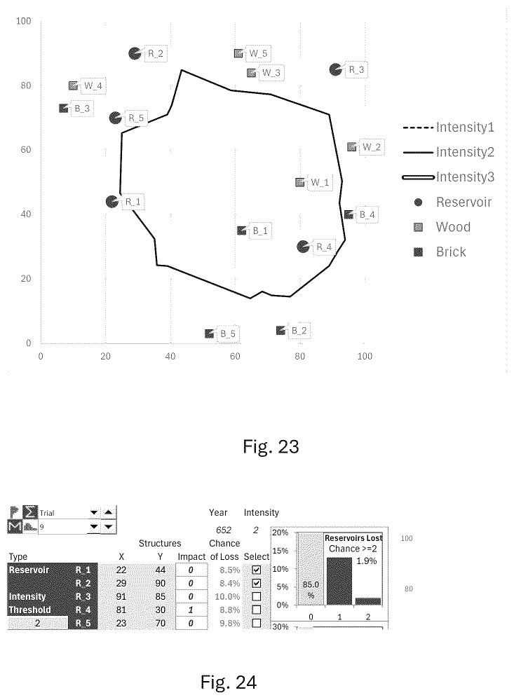

The Impact column determines if that structure is in the fire polygon and is vulnerable to the intensity. Trial 9 is displayed (see FIG. 23), for which a Level 2 fire surrounds R_4, W_1, and B_1. The first two are impacted, with thresholds less than or equal to that of the fire. B1 is not impacted because its threshold is higher than the fire on this trial.

### FIG. 23: Map

The map displays the locations of all assets and the fire polygon for the current trial, in this case 9.

### Exploring the Model

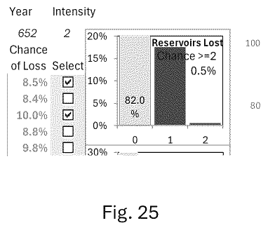

Referring to FIGS. 24-25, the goal is to choose the two reservoirs out of five that have the lowest chance of both being contaminated in the same fire, as that would catastrophically disrupt the entire water supply. Note again that the obvious choice is to pick the two with the lowest chance of loss. That would be R_1 and R_2 as shown, each with around an 8.5% annual chance of loss. If you recall your probability theory, if the losses are independent, than the chance of losing both is 8.5%×8.4%=0.71%. Looking at the histogram on the right, we see that the chance of losing both at once is 1.9%, more than twice what we were expecting. This is due to high spatial correlation of fires impacting these two reservoirs. Deselect R_2 in column G and replace it with R_3, which has the highest annual chance of loss. Now the chance of losing both is 0.5%. So, in conclusion, choosing the two with the lowest chance of loss resulted in roughly four times the risk of losing both reservoirs than choosing the one reservoir with the highest annual chance of loss!

This proves two things. First, we must go beyond using only average hazards.

Second you should not waste your time trying to solve problems like this in your head. For this little problem there are ten combinations of two reservoirs of which we have only looked at two. These sorts of problems are amenable to powerful methods of mathematical optimization which have been honed in the financial and insurance industries. But as fuel they require simulated coherent scenarios like the ones in these models, not averages.

### Sparse Monte Carlo

While modeling the risk of very rare pipe ruptures over a gas transmission network of roughly 100,000 assets, we developed a method we call Sparse Monte Carlo. An implementation of this approach in Analytica from Lumina Decision Systems may be viewed here.

### The Flaw of Averages

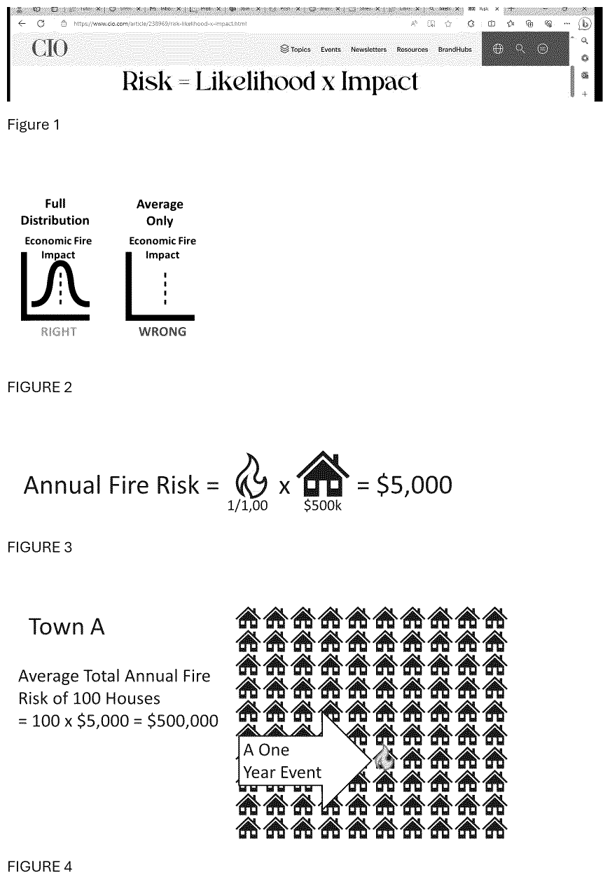

Referring to FIG. 1, a common definition of risk is Risk=Likelihood×Impact. Mathematically this is the average impact that one would expect and, as such, runs afoul of the Flaw of Averages. For example, consider two risks. One involves one chance in 10 of a single fatality, while the other involves one chance in ten million of one million fatalities. If we calculate the two risks according to the above definition, we have:

Risk 1= 1/10×1=0.1 fatalities, while Risk 2= 1/10,000,000×1,000,000=0.1 fatalities.

The risk scores are equal! Yet these cannot be considered to be the same risk.

### Averages Mask Spatial Interrelationships

Referring to FIGS. 2-3, although large wildfire models may accurately capture the implications of prevailing winds, humidity, fuel load, and other variables to predict geographical fire spread, the results are typically conveyed as the average annual wildfire risk at a given location. This is calculated as the product of the annual likelihood of fire at that location, extracted from the wildfire model, multiplied by the expected consequence of wildfire at that location based on the assets at that location. Consider a single asset: a house worth $500,000 with one chance in 100 of burning down next year. The average annual fire risk is calculated as $5,000, as shown in FIG. 3.

Referring to FIGS. 4-5, averages do have one useful property, they are additive. That is, imagine Town A consisting of 100 such houses. It is easy to calculate the average risk for the town as a whole, as follows:

Average annual total fire risk of Town A=100 times the risk of 1 house, or 100×$5,000=$500,000.

Assuming that the fires are independent, then one can expect one of the 100 houses to burn down every year on average. That is in town A, a house fire is a “One Year Event.”

But the assumption that the fires are independent is dangerous. Imagine Town B as shown in FIG. 5, which also has 100 such houses. Again, each $500 k house has a 1/100 chance of burning each year, but in this case, instead of 1 house burning every year, on average, all 100 houses burn down at once every hundred years. There is a lock-step interrelationship between fire at any house, and fire at all the other houses, the total loss of the town is a 100 year event. Averages are blind to these interrelationships so the average annual risk for Town B is found the same way we did it for Town A: $500,000.

Imagine that you are the disaster planner for Town A or Town B. Each planner gets the same risk information: “Your average annual fire risk is $500,000.” Does that mean the two towns should have the same disaster plan? Of course not. Town B faces an existential threat. But you would never know it from the average.

### Modular Architecture

### Monolithic Climate Models

Climate risks are typically modelled with large monolithic computer simulations which represent uncertainty explicitly, as in rolling dice. These models often include both simulated Hazards and Impacted Assets for a particular region of interest. For example Wildfires relative to Houses that can burn down. Such simulations are highly evolved and may be applied at various levels of granularity. They may need to run for days to get statistically stable results. The outputs consist of detailed probability distributions that capture the potential economic impact of wildfire in the specified region.

With this monolithic architecture, if a single large new building is built, or the region of interest is extended to include a separate county, the entire simulation needs to be re-run to determine the change to overall fire impact. Furthermore, monolithic models are difficult to maintain and may collapse under their own weight.

Separating Hazards from Assets

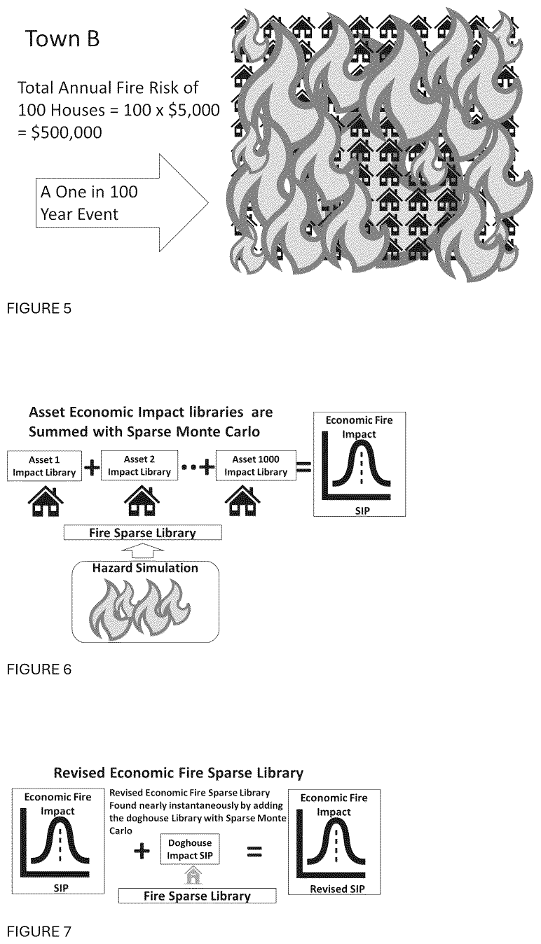

Referring to FIGS. 6-9, Sparse Stochastic Libraries may be used to disaggregate monolithic models into separate sub models that may be simulated asynchronously, for example, Hazards and Assets. Each sub model produces a Sparse Stochastic Library, which may be aggregated using methods described in at least one of the above-referenced patents to produce a Sparse Stochastic Library of the total.

Assume that we are modeling the fire risk of a municipality with 1,000 buildings. From a theoretical perspective this represents the same total number of calculations as the monolithic approach, but it offers numerous advantages, including model simplicity, scalability, extensibility, and additivity across hazards. An embodiment represents uncertainties as arrays of thousands of potential outcomes, called Stochastic Information Packets or SIPs.

Model simplicity. The monolithic approach not only contains a complex climate hazard model, but also 1,000 fragility curves, that is, the impact for each house based on the intensity of fire, which is driven by the fire result to calculate the economic impact for each building. In the modular approach, the hazard simulation module stands alone, decreasing complexity and increasing speed. We still need to run the fire SIP Library through each of the buildings, but this can be done in parallel, asynchronously, and potentially on different computer platforms.

Scalability. Suppose after the simulation is run, we want to add a building. To emphasize that this works at any scale, we will revise total fire risk to include a doghouse that was left out of the original simulation as shown in FIG. 7. Note that the Hazard Simulation does not need to be rerun because the same Fire SIP Library may be used to create the Doghouse Impact SIP. This is added to the Economic Fire Impact SIP using vector arithmetic with the whole process potentially occurring nearly instantaneously.

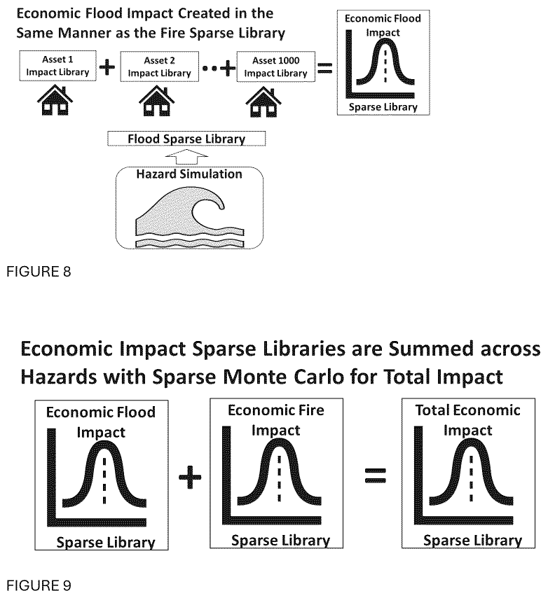

Extensibility. Consider other hazards, for example earthquake, or flood as shown in FIG. 8. Some of these will be independent of each other, while wind damage would need to be coupled to flood in coastal regions.

### Additivity

Total Economic Risks across all hazards may be found nearly instantaneously by merely adding the Economic Impact SIPs of the various hazards using vector arithmetic as shown in FIG. 9.

### The Inadequacy of Conventional Stochastic Libraries for Climate Risks

Consider a square 10 km by 10 km area, which has of average one fire per year, divided into 10 m by 10 m grid squares for modeling wildfire. The area would have 1,000 grid squares per side or a total of 1 million square to model. To properly model the ignitions and spread of potential fires over the entire area, one might want to simulate 100,000 years and such a simulation might run for several days. This data is useful to others for measuring risk to properties on the area. However, to store these results with spatial correlation in a traditional statistically coherent stochastic libraryⁱ would require 100,000×1 million=100 billion numbers. So often only the likelihood of burn in each of the million squares would be saved, in one million numbers. As discussed above, this approach will not distinguish the total risk for Town A from Town B. ⁱ https://en.wikipedia.org/wiki/Probability_management

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and system described herein are illustrative only and are not limiting upon the scope of the claims.

For applications examples related to spatial correlation, for example, with wildfire see https://www.probabilitymanagement.org/s/CHANCES-Demo-Models-3-30-2024.pdf

### First Set of Numbers.

These are the sparse trial numbers of significant events, and may be generated in one of two ways

From theory we may know the frequency of the rare event. For example, suppose we know that there is a 1 in 1 million year chance of a particular risk event. That means there will be 100 such events in a 100-million-year simulation. Instead of running all 100 million trials, we can just generate 100 numbers uniformly distributed between 1 and 100 million as our first set of numbers, representing the trials on which such events will occur. For each of these first numbers we generate a 2nd number, representing the severity of the risk event for the trial represented by the first number.

b. In the event that the first numbers cannot be determined in advance, it may be necessary to run one hundred million trials, potentially on a first computer program. Then those numbers for which an event occurred may potentially conveyed to a 2nd computer program where the 2nd numbers are generated.

Dealing with Emergent Risks with Sensors

With natural hazards or many national security situations, there may not be time to do real time analysis. However, if sufficient sparse simulation have been done in advance, then AI or other pattern recognition may be able to identify small subsets of the pre-generated sparse Monte Carlo data to be used in real time decision making. Environmental sensors such as windspeed, or Signal Intelligence in national security situations could provide real-time input to such a system.

What is claimed is:

1. At least one computer-readable medium that, when executed by one or more processing devices, enables the one or more processing devices to perform a method, the method comprising the steps of:
executing a hazard simulation module to produce a first array of numerical data representing multiple potential hazard outcomes affecting multiple assets;
creating second and third arrays of numerical data representing multiple potential outcomes respectively affecting first and second ones of the multiple assets from the first array; and
adding the second and third arrays to produce a fourth array of numerical data representing an economic hazard impact on the multiple assets.

2. At least one computer-readable medium that, when executed by one or more processing devices, enables the one or more processing devices to perform a method, the method comprising the steps of:
defining a set of multiple assets;
performing multiple simulations representing a hazard impacting at least one of the assets; and
for each simulation, generating an electronic map depicting the assets and their respective positions with respect to each other, the coordinates of each asset on the map, an impact column indicating whether an asset has been impacted and a geometric polygon on the map indicating the area in which the hazard occurred and which assets were impacted by the hazard.
